(19) United States
(12) Patent Application Publication
(10) Pub. No.: US 2014/0348207 A1
(43) Pub. Date: Nov. 27, 2014

(54) TEMPERATURE PROBE FOR A TEMPERATURE CONTROL UNIT

(71) Applicant: MARINE CANADA ACQUISITION INC., Richmond, CA (US)

(72) Inventors: Bruce Wilnechenko, Burnaby (CA); Greg Eastman, Mississauga (CA); Steve Locke, Mississauga (CA)

(73) Assignee: MARINE CANADA ACQUISITION INC., Richmond (CA)

(21) Appl. No.: 14/368,163

(22) PCT Filed: Dec. 24, 2012
(86) PCT No.: PCT/CA2012/050942

§ 371 Date: Jun. 23, 2014

Related U.S. Application Data
(60) Provisional application No. 61/580,061, filed on Dec. 23, 2011.

(51) Int. Cl. G01K 7/02

(52) U.S. Cl. CPC G01K 7/02
USPC 374/179; 29/595

(57) ABSTRACT

A temperature probe comprises a thermocouple with a cross-section having flattened sides and rounded ends, and a method of manufacturing a thermocouple for a temperature probe comprising the step of flattening a round thermocouple wire.

### BACKGROUND OF THE INVENTION

1. Field of the Invention

The present invention relates to a temperature probe and, in particular, to a temperature probe for a temperature control unit.

2. Description of the Related Art

The United States military is known to utilize modular appliances for cooking and sanitation applications in the field. The heat source in these appliances may be supplied by the burner unit disclosed in U.S. Pat. No. 6,450,801 which issued on Sep. 17, 2002 to Wilnechenko et al., and the full disclosure of which is incorporated herein by reference. The heat output of the burner unit disclosed by Wilnechenko et al. is adjustable using a control knob. However, the adjustment is an open loop control configuration, i.e. adjust up for more heat and adjust down for less heat. The control configuration accordingly has no easy means for controlling a specified heat load. The heat output, even at low settings, is therefore sometimes higher than desired.

To control a specified heat load a closed loop control configuration is desired. This may be facilitated through the use of a temperature control unit similar to the type disclosed in U.S. Pat. No. 8,141,788 which issued on Mar. 27, 2012, to Schwartzman et al., and the full disclosure of which is incorporated herein by reference. The temperature control device includes a temperature probe electrically connected to a controller which in turn is connected to a burner unit by a harness. The temperature probe is located in the appliance remotely from a controller and provides a temperature feedback signal to the controller. The controller compares the measured temperature in the appliance to a desired temperature point previously set by a user to determine if more or less heat is required. The burner unit is switched on or off based on a control software algorithm.

### SUMMARY OF THE INVENTION

It is an object of the present invention to provide an improved temperature probe for a temperature control unit.

There is accordingly provided a temperature probe comprising a thermocouple with a cross-section having flattened sides and rounded ends, and a method of manufacturing a thermocouple for a temperature probe comprising the step of flattening a round thermocouple wire.

### BRIEF DESCRIPTIONS OF DRAWINGS

The invention will be more readily understood from the following description of the embodiments thereof given, by way of example only, with reference to the accompanying drawings, in which:

FIG. 1 is perspective view of an improved temperature probe;

FIG. 2 is a side elevation view of the temperature probe of FIG. 1;

FIG. 3 is a cross-sectional view taken along lines A-A of FIG. 2;

FIG. 4 is a cross-sectional view taken along lines B-B of FIG. 2;

FIG. 5 is a perspective view of a connector of the temperature probe of FIG. 1;

FIG. 6 is an end view of a first end of the connector of FIG. 5;

FIG. 7 is an end view of a second end of the connector of FIG. 5;

FIG. 8 is an elevation view of the connector of FIG. 5;

FIG. 9 is a cross-sectional view taken along lines C-C of FIG. 8;

FIG. 10 is a schematic illustrating the wiring of the temperature probe of FIG. 1; and

FIGS. 11 to 13 are schematics illustrating the construction of a thermocouple of the temperature probe of FIG. 1.

### DESCRIPTIONS OF THE PREFERRED EMBODIMENTS

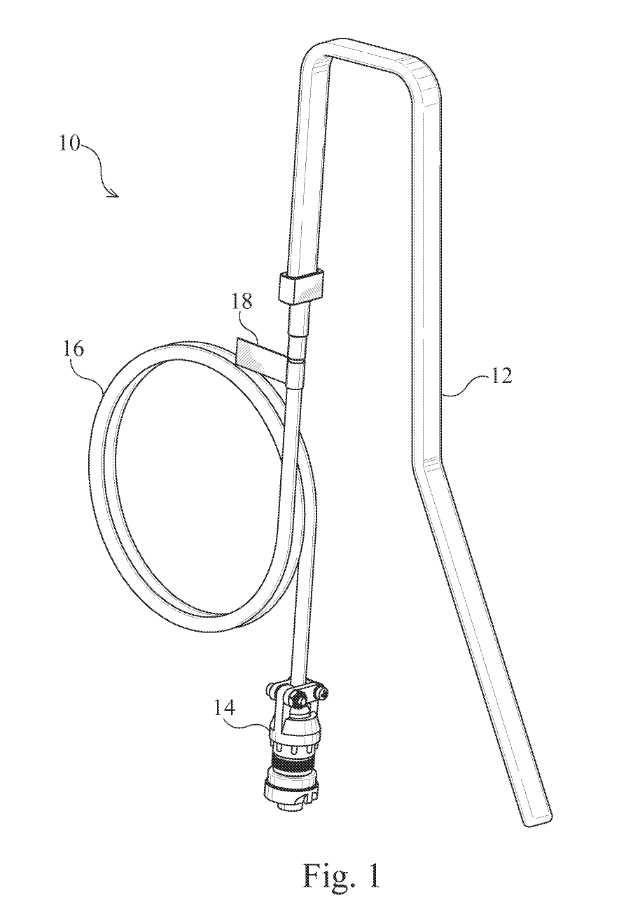

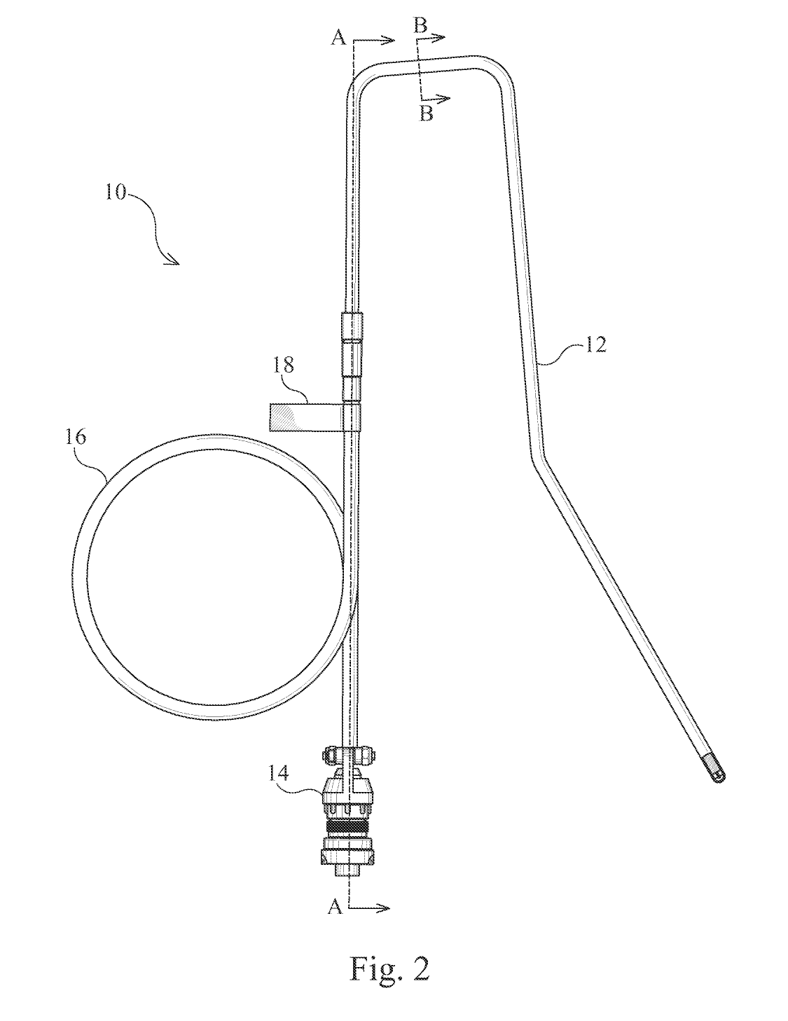

Referring to the drawings and first to FIGS. 1 and 2 an improved temperature probe 10 is shown. The temperature probe 10 generally comprises a thermocouple 12 for measuring temperature differences, a connector 14 for connecting the temperature probe to a thermostatic control unit (not shown), and an extension cable 16 connecting the thermocouple 12 to the connector. The temperature probe may also include a Quality Control label 18.

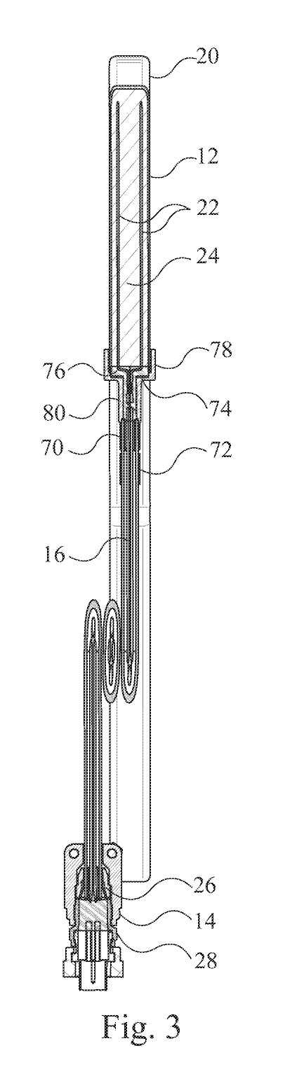

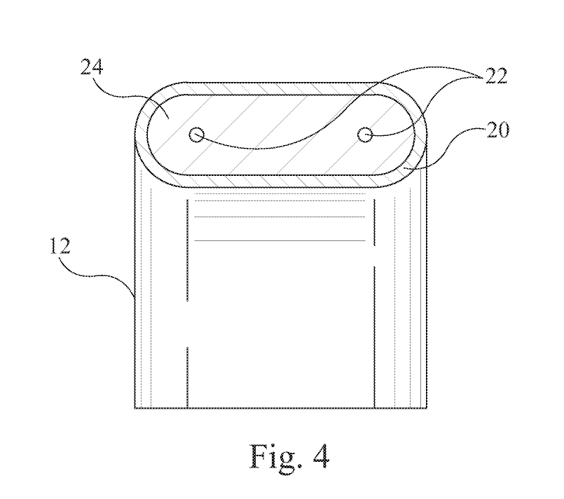

Referring now to FIG. 3, the thermocouple 12 has an outer shell 20 and a thermocouple wire 22 disposed therein. The thermocouple wire 22 is encased in an insulating material 24. In this example, and as best shown in FIG. 4, the thermocouple 12 has a cross-section with a flattened sides and rounded ends. Alternatively, the thermocouple may have either an elliptical or oval cross-section. In this example, the outer shell 20 has a wall thickness of approximately 0.028 inches and the thermocouple has a width of approximately 0.650 inches. The thermocouple wire 22 is a thermocouple wire—Type K of 24 American Wire Gauge. The insulating material 24 is MgO of approximately 93% purity, in this example.

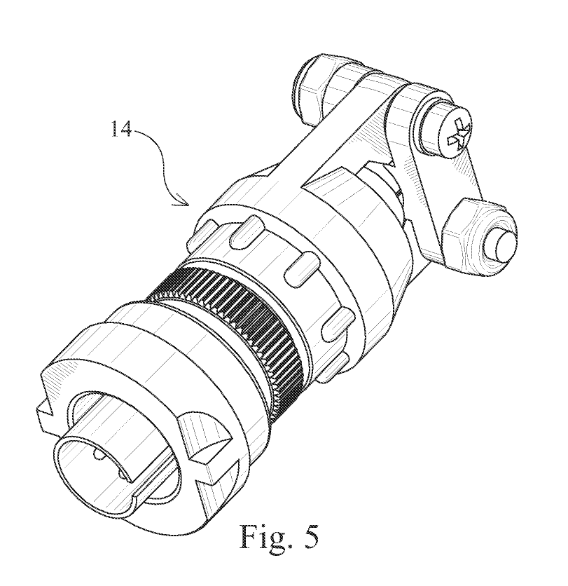

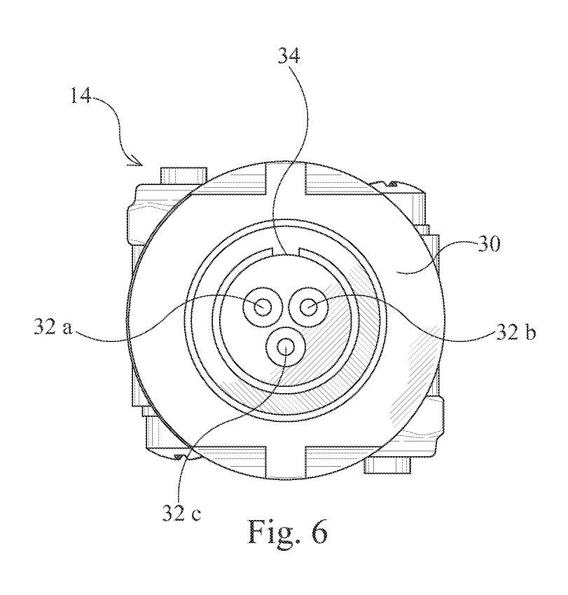

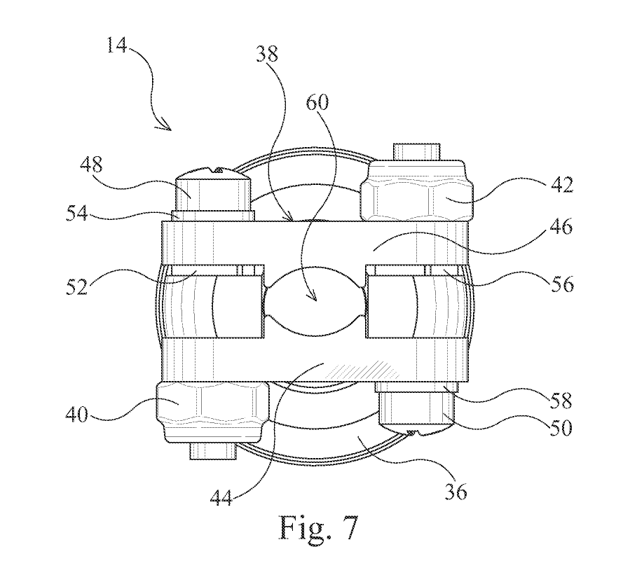

Referring back to FIG. 3, the connector 14 has an eyelet 26 and a circulate connector 28. The connector 14 is better shown in FIGS. 5 to 9. FIG. 5 shows a perspective view of the connector 14. FIG. 6 shows a first end 30 of the connector 14. The first end 30 of the connector 14 is provided with a plurality of pins 32A, 32B and 32C disposed on a connector alignment key 34 to allow the connector 14 to be coupled to a thermostatic control unit (not shown). The pins 32A, 32B and 32C may be crimp pins or solder pins. FIG. 7 shows a second end 36 of the connector 14. There is a cable clamp 38 at the second end 36 of the connector 14 for clamping the connector 14 to the extension cable 16 as shown in FIGS. 1 to 3. Referring back to FIG. 7, the cable clamp 38, in this example, includes a pair of Nylock jam nuts 40 and 42, a pair of cable clamp bars 44 and 46, a pair of screws 48 and 50, and a plurality of split lock-washers 52, 54, 56 and 58. An opening 60 receives and clamps the extension cable 16 as shown in FIGS. 1 to 3.

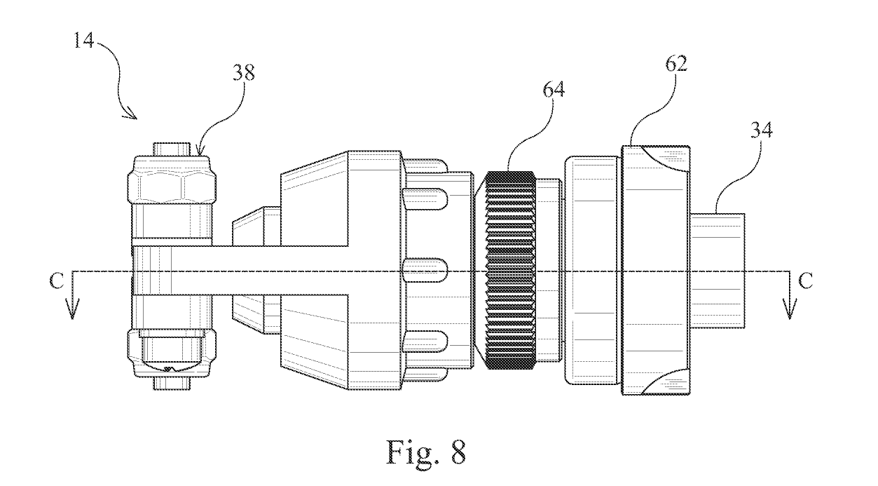

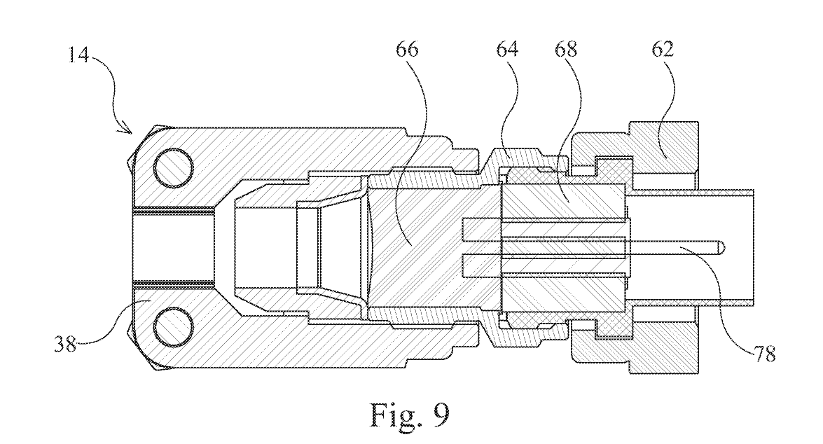

FIG. 8 is an elevation side view of the connector 14 with the connector alignment key 34 and the cable clamp 38 at opposite ends thereof. There is a threaded standard plug 62 adjacent the connector alignment key 34. There is also an end bell 64 between the threaded standard plug 62 and the connector alignment key 34. FIG. 9 is a cross-sectional view taken along lines C-C of FIG. 8. There is a Military Standard potting connector 66 disposed within the connector. The potting connector 66 is coupled to a contact pin seal insert 68 from which the pins, for example pin 32A, extend.

Referring back to FIG. 3, the thermocouple 12 is coupled to the extension cable 16 by an eyelet 70 which is mated to instrumentation tubing 72. In this example, a proximal end portion 74 of the thermocouple wire 22 is encased in an anti-shortening separator 76. The anti-shortening separator 76 is set in a probe transition fitting 78. The proximal end portion of the thermocouple wire 22 then extends through an epoxy potting material 80 to the eyelet 70. In this example, the anti-shortening separator 76 is fibreglass and the probe transition fitting is a silver solder/braze.

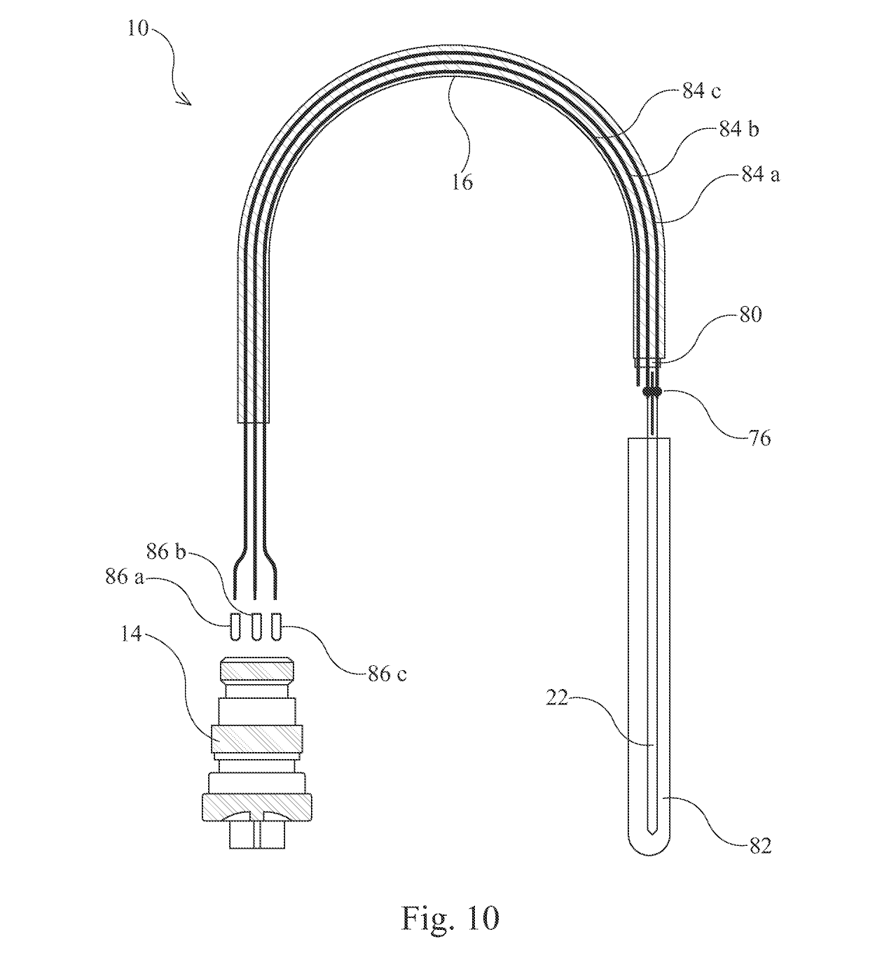

The wiring of the temperature probe 10 is more generally shown in FIG. 10. A distal end 82 of the thermocouple wire 22 is an ungrounded thermocouple junction. The proximal end portion 76 of the thermocouple wire 22 extends through the fibreglass anti-shortening separator 76 and epoxy potting material 80 and is then coupled to the extension cable 16. In this example, the extension cable 16 has three wires: 84A which is negative wire, 84B which is a positive wire, and 84C which is a ground wire. The extension cable 16 according has a positive polarity. Pins 86A, 86B and 86C respectively connect wires 84A, 84B and 84C to the connector 14.

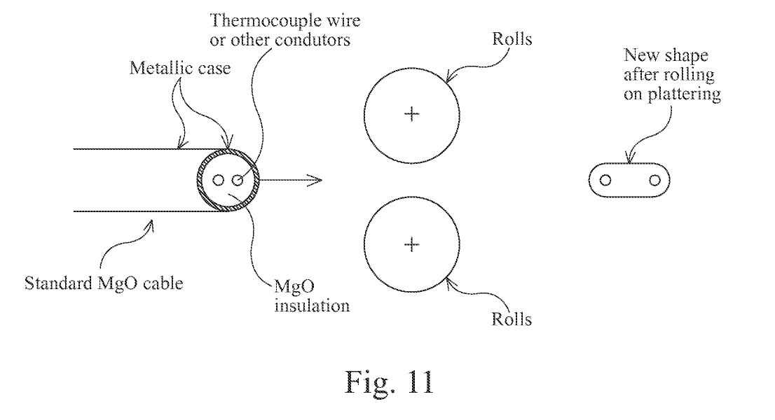

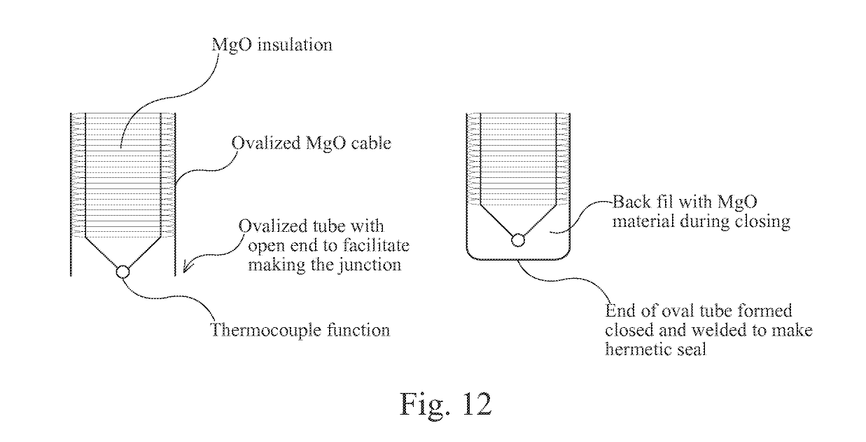

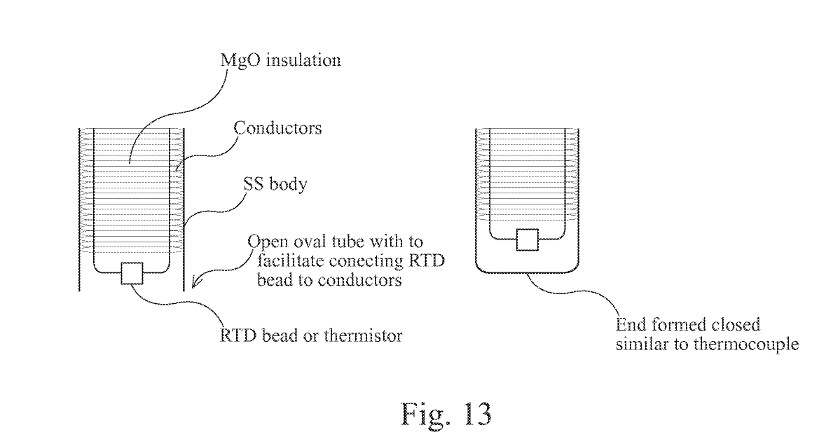

The thermocouple 12 may be constructed, as shown schematically in FIGS. 11 to 13, from a round MgO thermocouple wire consisting of a metallic casing (e.g. a stainless steel outer shell) having thermocouple wires disposed therein which are surrounded by MgO insulation. The round MgO thermocouple wire may be flattened by rolling as shown in FIG. 11. Alternatively, the MgO thermocouple wire may be flattened by stamping or drawing. As shown in FIGS. 12, a cold junction may be formed at a distal end of the flattened tube with said end of the oval tube being welded closed to hermetically seal the tip. As shown in FIG. 13, alternatively, a resistive thermal device, for example a thermistor 83, may be soldered to the distal ends of the thermocouple wire with said end of the oval tube being welded closed to hermetically seal the tip. The proximal ends of the thermocouple are then soldered to the temperature probe. The thermocouple may be bent into a desired shape to allow for engagement with an appliance (not shown).

It will be understood by a person skilled in the art that many of the details provided above are by way of example only, and are not intended to limit the scope of the invention which is to be determined with reference to the following claims.

What is claimed is:

1. A temperature probe comprising a thermocouple with a cross-section having flattened sides and rounded ends.

2. A method of manufacturing a thermocouple for a temperature probe comprising the step of flattening a round thermocouple to form a thermocouple with a cross-section having flattened sides and rounded ends.
